(19) United States
(12) Patent Application Publication
(10) Pub. No.: US 2014/0346904 A1
(43) Pub. Date: Nov. 27, 2014

(54) SWITCHED RELUCTANCE MOTOR

(71) Applicant: SAMSUNG ELECTRO-MECHANICS CO., LTD., Suwon-Si (KR)

(72) Inventors: Hee Soo YOON, Suwon (KR); Han Kyung Bae, Suwon (KR); Sung Tai Jung, Suwon (KR); Sung Jun Leem, Suwon (KR); Sang Jong Lee, Suwon (KR); Joon Sik Shin, Suwon (KR)

(73) Assignee: SAMSUNG ELECTRO-MECHANICS CO., LTD., Suwon-Si (KR)

(21) Appl. No.: 14/280,429

(22) Filed: May 16, 2014

(30) Foreign Application Priority Data
May 27, 2013 (KR) 10-2013-0059686

(51) Int. Cl. H02K 1/02; H02K 1/24; H02K 1/14

(52) U.S. Cl. CPC H02K 1/02; H02K 1/14; H02K 1/24
USPC 310/46

(57) ABSTRACT

Disclosed herein is a switched reluctance motor comprising: a rotor having a shaft disposed at a central portion thereof and having salient poles formed at an outer circumference thereof; a stator having the rotor rotatably installed therein while forming a gap and having salient poles facing the salient poles of the rotor; and an extraction pressure decreasing unit separating the rotor and the stator from a mold, wherein the rotor and the stator are made of a soft magnet composite (SMC).

### CROSS REFERENCE TO RELATED APPLICATION

This application claims the benefit of Korean Patent Application No. 10-2013-0059686, filed on May 27, 2013, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

In a switched reluctance motor (SRM), both of cores of a stator and a rotor are formed in a magnetic structure, which is a salient pole, and a concentrated type coil is wound only around the stator without forming any excitation device (a winding or a permanent magnet) in the rotor.

The switched reluctance motor (SRM), which rotates the rotor using a reluctance torque according to a change in magnetic reluctance, has a low manufacturing cost, hardly requires maintenance, and has an almost permanent lifespan due to high reliability.

Meanwhile, the switched reluctance motor generally includes the stator and the rotor formed in a scheme in which steel plates are stacked, which is specifically disclosed in Patent Document 1. That is, Patent Document 1 has disclosed a switched reluctance motor in which steel plates are stacked on a shaft disposed at the center of the switched reluctance motor to form a body and a plurality of salient poles are formed on an outer peripheral surface of the body to configure a rotor.

However, Patent Document 1 discloses only the rotor of the switched reluctance motor. That is, the stator is generally formed in the same scheme, which is known. In addition, steel plates used in known switched reluctance motors including the switched reluctance motor disclosed in Patent Document 1 are silicon steel plates (S60). That is, a plurality of silicon steel plates are molded in the same shape and are then stacked as described above to form the rotor and the stator.

However, in the switched reluctance motor rotated using a mutual induction action, when the stator and the rotor are formed of the steel plates, an eddy current is generated, such that magnetic loss is generated. In addition, when the stator and the rotor are molded using the steel plates, a degree of freedom is limited, such that it is difficult to form a free structure. Therefore, there is a limitation in increasing reluctance and miniaturizing the stator and the rotor.

### PRIOR ART DOCUMENT

### Patent Document

(Patent Document 1) KR2004-0042036 A

### SUMMARY OF THE INVENTION

Therefore, an object of the present invention is to solve problems generated in the case in which steel plates are stacked to form a stator and a rotor in a switched reluctance motor according to the prior art including a switched reluctance motor disclosed in Patent Document 1.

The present invention has been made in an effort to provide a switched reluctance motor having structures of a stator and a rotor that may be easily designed without using steel plates.

According to a preferred embodiment of the present invention, there is provided a switched reluctance motor including: a rotor having a shaft disposed at a central portion thereof and having salient poles formed at an outer circumference thereof; a stator having the rotor rotatably installed therein while forming a gap and having salient poles facing the salient poles of the rotor; and an extraction pressure decreasing unit separating the rotor and the stator from a mold, wherein the rotor and the stator are made of a soft magnet composite.

The extraction pressure decreasing unit may be formed of a lubricant added to the soft magnet composite.

The lubricant may be a low viscosity liquid lubricant.

The soft magnet composite may be heat-treated at a temperature of 450° C.

The extraction pressure decreasing unit may be formed of an inclined part formed at a side surface of the stator or the rotor.

According to another preferred embodiment of the present invention, there is provided a switched reluctance motor including: a rotor having a shaft disposed at a central portion thereof and having salient poles formed at an outer circumference thereof; a stator having the rotor rotatably installed therein while forming a gap and having salient poles facing the salient poles of the rotor; and a gap bent between the rotor and the stator, wherein the rotor and the stator are made of a soft magnet composite.

The gap may be bent in a straight line.

The gap may be bent in a straight line forming a right angle.

The gap may be bent in a straight line forming an oblique line.

The gap may be bent in a round form.

The soft magnet composite may have a low viscosity liquid lubricant added thereto.

The soft magnet composite may be heat-treated at a temperature of 450° C.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view showing a switched reluctance motor according to a first preferred embodiment of the present invention;

FIG. 2 is a cross-sectional view taken along the line A-A′ of FIG. 1;

FIG. 3 is a plan view showing a switched reluctance motor according to a second preferred embodiment of the present invention;

FIG. 4 is a cross-sectional view taken along line B-B′ of FIG. 3;

FIG. 5 is a cross-sectional view showing a switched reluctance motor according to a third preferred embodiment of the present invention;

FIG. 6 is a cross-sectional view showing a switched reluctance motor according to a fourth preferred embodiment of the present invention;

FIG. 7 is a cross-sectional view showing a switched reluctance motor according to a fifth preferred embodiment of the present invention; and

FIG. 8 is a cross-sectional view showing a switched reluctance motor according to a sixth preferred embodiment of the present invention.

FIG. 9 is a graph comparing the soft magnet composite (SMC) with a core loss value of a steel plate according to the prior art for each frequency.

FIG. 10 is a graph of comparing the magnetic properties (B-H) depending on a density of the soft magnet composite with each other.

FIG. 11 is a graph of showing strength characteristics to a heat treatment temperature at the time of manufacturing the rotor and the stator using the soft magnet composite (SMC).

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

A switched reluctance motor (SRM) according to a preferred embodiment of the present invention includes: a rotor having a shaft disposed at a central portion thereof and having salient poles formed at an outer circumference thereof; and a stator having the rotor rotatably installed therein while forming a gap and having salient poles facing the salient poles of the rotor.

Here, the rotor and the stator is made of a soft magnet composite (SMC) prepared by coating a magnetic particle in a composite form with an inorganic material for electrical insulation. The following Table 1 and FIG. 9 are table and graph of comparing the soft magnet composite (SMC) with a core loss value of a steel plate (S60) according to the prior art for each frequency. It could be seen in Table 1 and Table 2 that the core loss value of the soft magnet composite (SMC) is significantly decreased as compared with the steel plate (S60) from 400 Hz or more, which is a high frequency.

That is, it could be appreciated that characteristics of the soft magnet composite (SMC) are more excellent than those of the steel plate (S60) according to the prior art when considering a core loss increase amount in a high frequency band. Therefore, in the switched reluctance motor rotated at a high speed (RPM) to generate a high frequency, the soft magnet composite is more appropriate for designing structures of the rotor and the stator than the steel plate (S60) according to the prior art.

TABLE 1

| Frequency | Soft magnet composite (SMC) | Steel plate (S60) |
|---|---|---|
| 50 Hz | 5.3 | 2.79 |
| 60 Hz | 6.46 | 3.55 |
| 100 Hz | 11.12 | 7.2 |
| 200 Hz | 24.42 | 20.24 |
| 300 Hz | 39.54 | 38.6 |
| 400 Hz | 56.51 | 62.07 |
| 500 Hz | 75.16 | 90.54 |
| 600 Hz | 95.55 | 123.57 |
| 700 Hz | 117.57 | 162.79 |
| 800 Hz | 140.01 | 205.17 |
| 900 Hz | 164.84 | 252.3 |
| 1000 Hz | 191.02 | 303.15 |
| 1100 Hz | 218.96 | 352.42 |
| 1200 Hz | 248.31 | 410.01 |
| 1300 Hz | 279.07 | 467.28 |
| 1400 Hz | 310.39 | 523.47 |
| 1500 Hz | 339.55 | 581.84 |

[Core loss unit: W/kg]

TABLE 2

| Revolution | | |
|---|---|---|
| per minute (rpm) | Soft magnet composite (SMC) | Steel plate (S60) |
| 30000 | 0.4563 | 0.517 |
| 35000 | 0.2851 | 0.3124 |
| 40000 | 0.201 | 0.1743 |
| 45000 | 0.1513 | 0.0619 |

[Unit: Nm]

The above Table 2 shows comparison results between torque values of the steel plates (S60) and the soft magnet composite (SMC) from 30000 to 45000 rpm, which is a mainly used band of the switched reluctance motor according to the preferred embodiment of the present invention. It could be appreciated that as a revolution per minute (rpm) band rises, improvement of a torque value when the rotor and the stator are designed using the soft magnet composite (SMC) lead to an increase in an output value.

Therefore, as seen in the above Tables, in the switched reluctance motor (SRM) generating the core loss due to a high frequency (400 Hz) while being rotated at a high speed (37500 rpm or more), in the case in which the soft magnet composite (SMC) instead of the steel plate (S60) according to the prior art is used, an output may be easily improved.

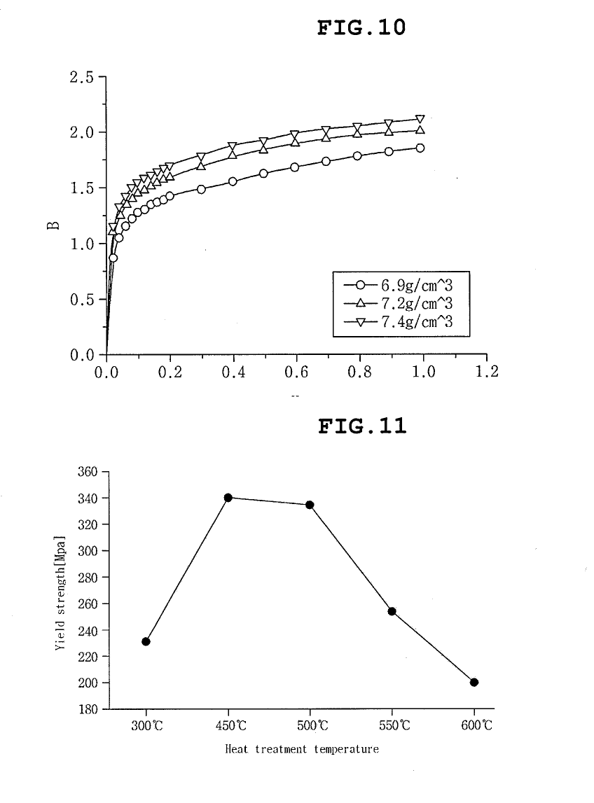

Here, the rotor and the stator made of the soft magnet composite (SMC) have different density distributions of the soft magnet composite (SMC) according to a shape or a position thereof, such that a difference may occur in a magnetic property (B-H) thereof. The following FIG. 10 is a graph of comparing the magnetic properties (B-H) depending on a density of the soft magnet composite with each other. It could be appreciated from Table 4 that a difference occurs in the magnetic property (B-H) of the soft magnet composite (SMC).

Therefore, the switched reluctance motor (SRM) according to the preferred embodiment of the present invention using the soft magnet composite (SMC) is affected by the magnetic property (B-H) depending on the density distribution, such that magnetic characteristics thereof may be deteriorated. Therefore, in order to minimize the deterioration of the magnetic characteristics, a lubricant is added to the soft magnet composite (SMC) to increase a density of the soft magnet composite (SMC).

In addition, a heat treatment temperature may be a factor having an effect on strength characteristics at the time of manufacturing the rotor and the stator using the soft magnet composite (SMC). It could be appreciated from the following FIG. 11 that strength characteristics are increased as the heat treatment temperature rises, but are decreased at a high temperature of 500° C. or more.

Therefore, in the switched reluctance motor (SRM) according to the preferred embodiment of the present invention, the rotor and the stator are formed using the soft magnet composite (SMC) to which the lubricant is added, wherein the soft magnet composite (SMC) is heat-treated at a temperature of 450° C. at which the strength characteristics thereof become excellent.

Meanwhile, in the switched reluctance motor (SRM) according to the preferred embodiment of the present invention, the rotor and the stator are formed in a compaction scheme of molding the rotor and the stator by inserting the soft magnet composite (SMC) in a mold and then pressing the soft magnet composite (SMC) at a high pressure. In this compaction process, pressing force is increased, such that the strength is increased. In addition, extraction pressure depending on separation of the rotor and the stator after molding the rotor and the stator may be high.

Therefore, the switched reluctance motor (SRM) according to the preferred embodiment of the present invention includes an extraction pressure decreasing unit for easily extracting the rotor and the stator from the mold. Here, the extraction pressure decreasing unit may use material characteristics of the soft magnet composite (SMC) or use structural characteristics of the rotor and the stator.

That is, in the extraction pressure decreasing unit using the material characteristics of the soft magnet composite (SMC), any one of a low viscosity liquid lubricant, a high viscosity liquid lubricant, and a solid lubricant is added to the soft magnet composite (SMC) to decrease the extraction pressure generated at the time of separating the rotor and the stator from the mold. In addition, in the extraction pressure decreasing unit using the structural characteristics of the rotor and the stator, outer side surfaces or inner side surfaces of the stator and the rotor are generally inclined to easily decrease the extraction pressure.

Meanwhile, in the switched reluctance motor (SRM) according to the preferred embodiment of the present invention, facing surfaces in a gap, which is an intermediate region of the rotor and the stator generating a torque, are increased using characteristics of the soft magnet composite (SMC).

That is, the facing surfaces of the rotor and the stator are freely formed in a straight line shape, a round shape, or the like, using the characteristics of the soft magnet composite (SMC) having a high degree of freedom in molding to increase a torque generation region, thereby easily improving an output of the switched reluctance motor according to the preferred embodiment of the present invention.

Hereinafter, preferred embodiments of the present invention will be described in detail with reference to the accompanying drawings.

### PREFERRED EMBODIMENT 1

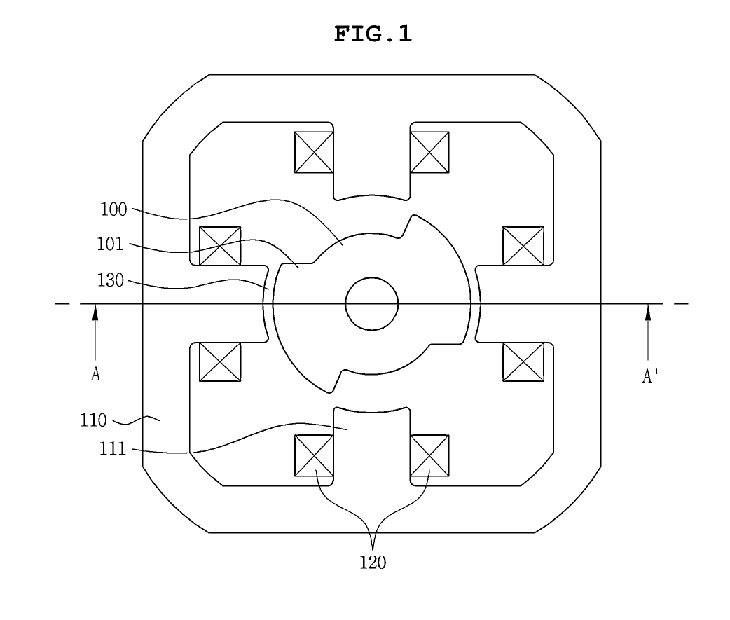

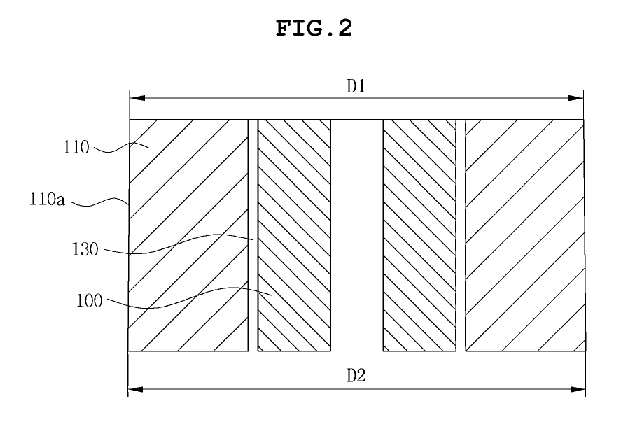

As shown in FIGS. 1 and 2, a rotor 100 is formed in a circular shape while having a shaft disposed at the center thereof, and a plurality of salient poles 101 are formed along an outer circumference. In addition, a stator 110 includes salient poles facing the salient poles 101 of the rotor 100 and having a coil 120 wound therearound, and the rotor 100 is rotatably disposed in the stator 110 while forming a gap 130 between the rotor 100 and the stator 110.

The above-mentioned rotor 100 and the stator 110 are examples of using the soft magnet composite (SMC) and are formed in a compaction scheme of inserting the soft magnet composite (SMC) in a mold and then pressing the soft magnet composite (SMC) at a high pressure. Therefore, loss of a material is not substantially generated as compared with a scheme of press-forming a steel plate according to the prior art.

Here, the rotor 100 and the stator 110 are formed by adding a low viscosity liquid lubricant (WD40) up to 0.8 wt % to the soft magnet composite (SMC) and performing heat treatment at a temperature of 450° C. Therefore, a density distribution and strength characteristics of the soft magnet composite (SMC) are improved. In addition, the low viscosity liquid lubricant (WD40) serves as the extraction pressure decreasing unit depending on the separation of the rotor 100 and the stator 110 from the mold.

TABLE 3

| | Extraction pressure (Ton) | | |
|---|---|---|---|
| | | Low | High viscosity |
| | Liquid lubricant | viscosity liquid | liquid |
| Pressure | is not used | lubricant | lubricant |
| Pressing pressure | 980 | 980 | 980 |
| (MPa) | | | |
| Extraction pressure | 3.2 | 2.0 | 3.05 |
| (Ton) | | | |

The above Table 3 is a table of comparing extraction pressures with each other when the low viscosity liquid lubricant (WD40) and the high viscosity liquid lubricant (Si-spray) are added to the soft magnet composite (SMC). It could be appreciated from Table 6 that the extraction pressure is significantly decreased in the case in which the liquid lubricant is used as compared with the case in which the liquid lubricant is not used, and in the case in which the low viscosity liquid lubricant is used.

As shown in FIG. 2, the stator 110 includes an inclined part 110a formed at the outer side surface thereof to easily decrease the extraction pressure from the mold. The inclined part 110a may be formed by designing an upper portion of the stator 110 so as to have a width narrower than that of a lower portion of the stator 110, that is, designing the lower portion of the stator 110 so as to have a diameter D2 larger than a diameter D1 of the upper portion of the stator 110.

Therefore, the stator 110 formed by molding the soft magnet composite (SMC) in the compaction scheme may be easily separated from the mold by the inclined part 110a formed at the outer side surface of the stator 110 as described above, which may be similarly applied to the rotor 100.

### PREFERRED EMBODIMENT 2

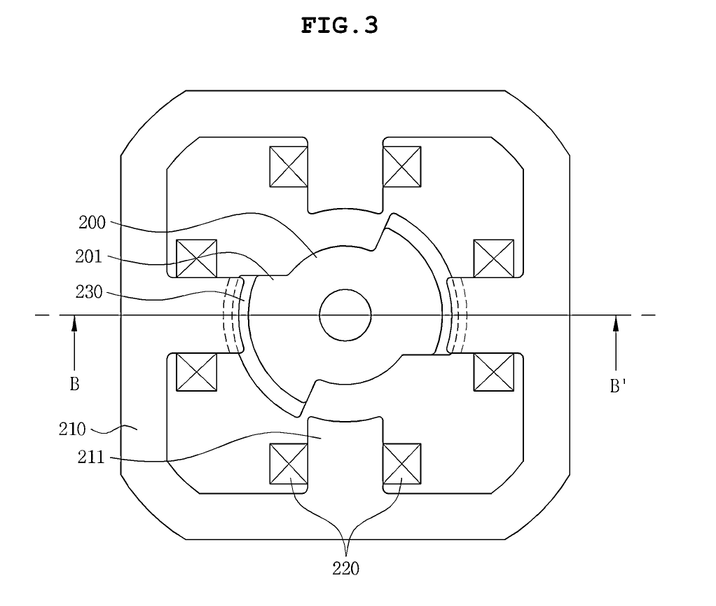

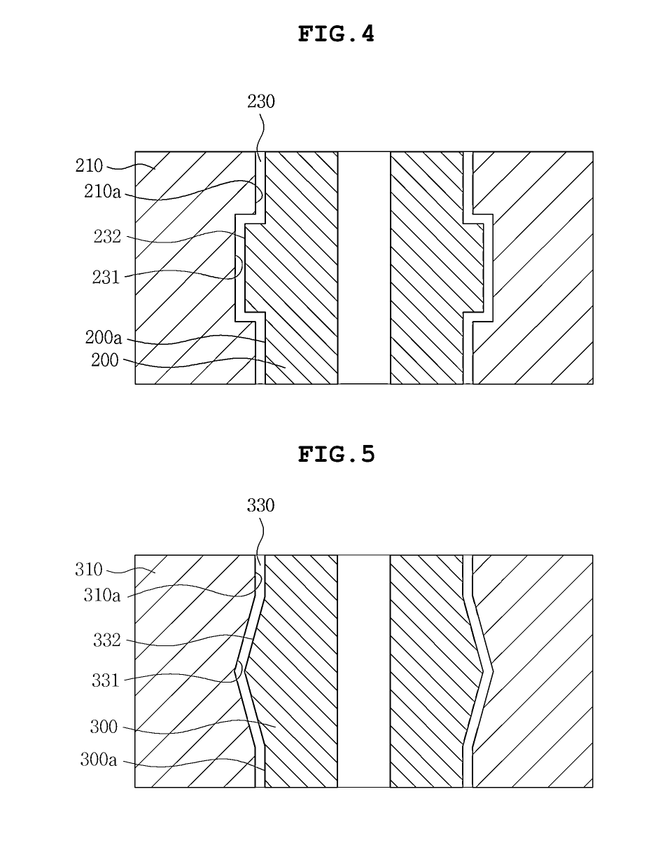

As shown in FIGS. 3 and 4, a rotor 200 is formed in a circular shape while having a shaft disposed at the center thereof, and a plurality of salient poles 201 are formed along an outer circumference. In addition, a stator 210 includes salient poles facing the salient poles 201 of the rotor 200 and having a coil 220 wound therearound, and the rotor 200 is rotatably disposed in the stator 210 while forming a gap 230 between the rotor 200 and the stator 210.

The above-mentioned rotor 200 and the stator 210 are examples and are formed in a compaction scheme of inserting the soft magnet composite (SMC) to which a low viscosity liquid lubricant is added in a mold and then pressing the soft magnet composite (SMC) at a high pressure at a temperature of 450° C.

Here, the rotor 200 and the stator 210 include a protrusion part 232 and a groove 231 formed at central portions of facing surfaces 200a and 210a facing each other, respectively, and forming a right angle so as to intersect with an axial direction, such that a gap 230, which is an intermediate region of the rotor 200 and the stator 210, is bent in a straight line form. Therefore, the facing surfaces 200a and 210a, which are torque generation regions, may be increased. This increase of the facing surfaces 200a and 210a leads to an increase in reluctance.

The following Table 4 is a table of comparing torques with each other in the case in which a central portion of the gap 230 is bent in the straight line form in which it forms a right angle and in the case in which the central portion of the gap 230 is not bent. It could be appreciated from Table 7 that a torque difference of about 44% is generated.

TABLE 4

| | Bent gap | Non-bent gap | Difference (%) |
|---|---|---|---|
| Torque (kg · cm) | 0.028 | 0.0157 | 44 |

### PREFERRED EMBODIMENT 3

As shown in FIG. 5, a rotor 300 and a stator 310 made of the soft magnet composite (SMC) include a protrusion part 332 and a groove 331 formed at central portions of facing surfaces 300a and 310a facing each other, respectively, and forming an oblique line so as to intersect with the axial direction, such that a gap 330, which is an intermediate region of the stator 310 and the rotor 300, is bent in a straight line.

Therefore, the facing surfaces 300a and 310a of the rotor 300 and the stator 310, which are torque generation regions, may be increased. This increase of the facing surfaces 300a and 310a leads to an increase in reluctance, thereby improving efficiency of the switched reluctance motor (SRM) and being advantageous for miniaturization.

The following Table 5 is a table of comparing torques with each other in the case in which the central portion of the gap 330 is bent in the straight line form in which it forms the oblique line and in the case in which the central portion of the gap 330 is not bent. It could be appreciated from Table 8 that a torque difference of about 45% is generated.

TABLE 5

| | Bent gap | Non-bent gap | Difference (%) |
|---|---|---|---|
| Torque (kg · cm) | 0.029 | 0.0157 | 45 |

### PREFERRED EMBODIMENT 4

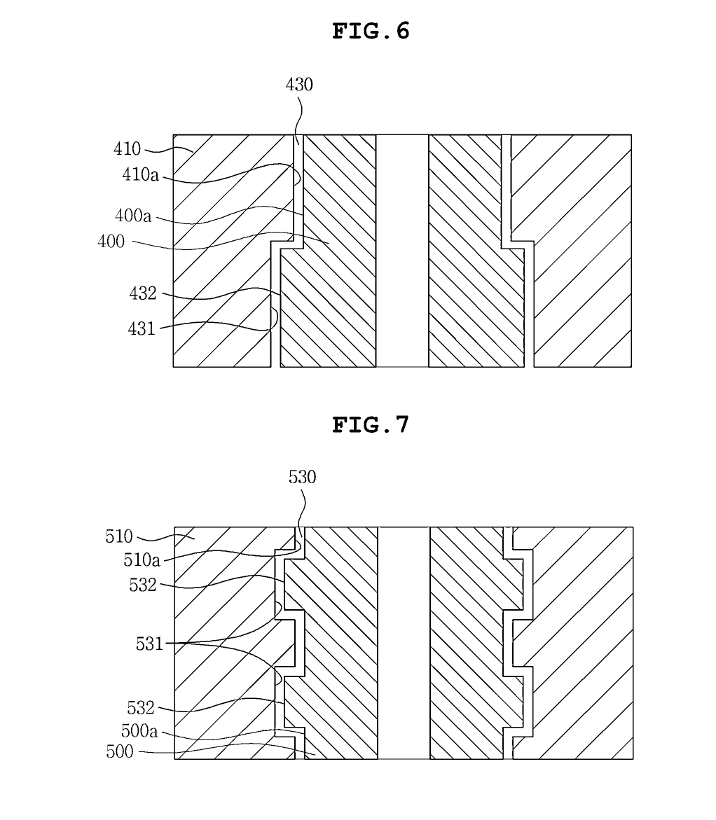

As shown in FIG. 6, a rotor 400 and a stator 410 made of the soft magnet composite (SMC) include a protrusion part 432 and a groove 431 formed at lower portions of facing surfaces 400a and 410a facing each other, respectively, and forming a right angle so as to intersect with the axial direction, such that a gap 430, which is an intermediate region of the stator 410 and the rotor 400, is bent in a straight line.

Therefore, the facing surfaces 400a and 410a of the rotor 400 and the stator 410, which are torque generation regions, may be increased. This increase of the facing surfaces 400a and 410a leads to an increase in reluctance, thereby improving efficiency of the switched reluctance motor (SRM) and being advantageous for miniaturization.

The following Table 6 is a table of comparing torques with each other in the case in which the lower portion of the gap 430 is bent in the straight line form in which it forms the right angle and in the case in which the lower portion of the gap 430 is not bent. It could be appreciated from Table 9 that a torque difference of about 43% is generated.

TABLE 6

| | Bent gap | Non-bent gap | Difference (%) |
|---|---|---|---|
| Torque (kg · cm) | 0.027 | 0.0157 | 43 |

### PREFERRED EMBODIMENT 5

As shown in FIG. 7, a rotor 500 and a stator 510 made of the soft magnet composite (SMC) include a protrusion part 532 and a groove 531 formed at upper and lower portions of facing surfaces 500a and 510a facing each other, respectively, and forming a right angle so as to intersect with the axial direction, such that a gap 530, which is an intermediate region of the stator 510 and the rotor 500, is bent in a straight line.

Therefore, the facing surfaces 500a and 510a of the rotor 500 and the stator 510, which are torque generation regions, may be increased. This increase of the facing surfaces 500a and 510a leads to an increase in reluctance, thereby improving efficiency of the switched reluctance motor (SRM) and being advantageous for miniaturization.

The following Table 7 is a table of comparing torques with each other in the case in which the upper and lower portions of the gap 530 are repeatedly bent in the straight line form in which they form the right angle and in the case in which the upper and lower portions of the gap 530 is not bent. It could be appreciated from Table 10 that a torque difference of about 47% is generated.

TABLE 7

| | Bent gap | Non-bent gap | Difference (%) |
|---|---|---|---|
| Torque (kg · cm) | 0.030 | 0.0157 | 47 |

### PREFERRED EMBODIMENT 6

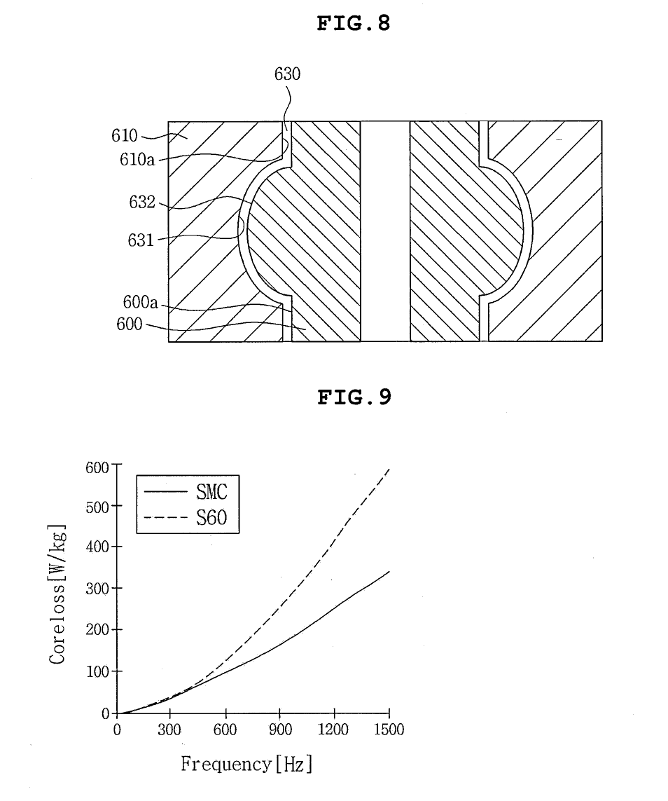

As shown in FIG. 8, a rotor 600 and a stator 610 made of the soft magnet composite (SMC) include an oval protrusion part 632 and groove 631 formed at central portions of facing surfaces 600a and 610a facing each other, respectively, so as to intersect with the axial direction, such that a gap 630, which is an intermediate region of the stator 610 and the rotor 600, is bent in a round form.

Therefore, the facing surfaces 600a and 610a of the rotor 600 and the stator 610, which are torque generation regions, may be increased. This increase of the facing surfaces 600a and 610a leads to an increase in reluctance, thereby improving efficiency of the switched reluctance motor (SRM) and being advantageous for miniaturization.

The following Table 8 is a table of comparing torques with each other in the case in which the central portion of the gap 630 is bent in the round form and in the case in which the central portion of the gap 630 is not bent. It could be appreciated from Table 11 that a torque difference of about 44% is generated.

TABLE 8

| | Bent gap | Non-bent gap | Difference (%) |
|---|---|---|---|
| Torque (kg · cm) | 0.028 | 0.0157 | 44 |

According to the preferred embodiments of the present invention, the structures of the rotor and the stator is designed using the soft magnet composite to increase a torque as compared with the steel plate according to the prior art, thereby making it possible to easily obtain a reluctance increase effect.

In addition, according to the preferred embodiments of the present invention, the bent gap is provided between the rotor and the stator to increase a torque generation region, thereby making it possible to more easily obtain the reluctance increase effect. Therefore, efficiency of the switched reluctance motor may be improved, and a structure advantageous for miniaturization may be designed.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A switched reluctance motor comprising:
a rotor having a shaft disposed at a central portion thereof and having salient poles formed at an outer circumference thereof;
a stator having the rotor rotatably installed therein while forming a gap and having salient poles facing the salient poles of the rotor; and
an extraction pressure decreasing unit separating the rotor and the stator from a mold, wherein the rotor and the stator are made of a soft magnet composite (SMC).

2. The switched reluctance motor as set forth in claim 1, wherein the extraction pressure decreasing unit is formed of a lubricant added to the soft magnet composite (SMC).

3. The switched reluctance motor as set forth in claim 2, wherein the lubricant is a low viscosity liquid lubricant (WD40).

4. The switched reluctance motor as set forth in claim 1, wherein the soft magnet composite (SMC) is heat-treated at a temperature of 450° C.

5. The switched reluctance motor as set forth in claim 1, wherein the extraction pressure decreasing unit is formed of an inclined part formed at a side surface of the stator or the rotor.

6. A switched reluctance motor comprising:
a rotor having a shaft disposed at a central portion thereof and having salient poles formed at an outer circumference thereof;
a stator having the rotor rotatably installed therein while forming a gap and having salient poles facing the salient poles of the rotor; and
a gap bent between the rotor and the stator, wherein the rotor and the stator are made of a soft magnet composite (SMC).

7. The switched reluctance motor as set forth in claim 6, wherein the gap is bent in a straight line.

8. The switched reluctance motor as set forth in claim 7, wherein the gap is bent in a straight line forming a right angle.

9. The switched reluctance motor as set forth in claim 7, wherein the gap is bent in a straight line forming an oblique line.

10. The switched reluctance motor as set forth in claim 6, wherein the gap is bent in a round form.

11. The switched reluctance motor as set forth in claim 6, wherein the soft magnet composite (SMC) has a low viscosity liquid lubricant added thereto.

12. The switched reluctance motor as set forth in claim 6, wherein the soft magnet composite (SMC) is heat-treated at a temperature of 450° C.
